(19) United States
(12) Patent Application Publication
(10) Pub. No.: US 2012/0249467 A1
(43) Pub. Date: Oct. 4, 2012

(54) APPLIANCE HAVING A TOUCH USER INTERFACE WITH A CURVED SURFACE

(75) Inventors: BARTLOMIEJ H. KOTALA, WIELUN (PL); JACEK KOWALSKI, WROCLAW (PL); RYAN K. ROTH, SAINT JOSEPH, MI (US)

(73) Assignee: WHIRLPOOL CORPORATION, BENTON HARBOR, MI (US)

(21) Appl. No.: 13/076,788

(22) Filed: Mar. 31, 2011

(51) Int. Cl. G06F 3/045

(52) U.S. Cl. 345/174

(57) ABSTRACT

An appliance having a touch user interface that includes a touch panel with a touch area and a printed circuit board with a capacitive touch sensor trace and wherein the printed circuit board is mounted to the touch panel such that the capacitive touch sensor trace is aligned with the touch area.

### BACKGROUND OF THE INVENTION

Contemporary appliances, an example of which includes automatic dishwashers, perform cycles of operation and often have electrical and mechanical components responsible for implementing the cycle of operation of the appliance, with one or more of the components controlling the operation of the other components. For example, a controller, such as a microprocessor-based controller, having a printed circuit board (PCB) with memory, as well as a user-interface, such as a control panel or keypad, may issue commands to the other components according to input received from the user via the user-interface.

### SUMMARY OF THE INVENTION

The invention relates to a user interface having a touch panel with a touch area on a front surface and where at least one portion of a rear surface is curved and a printed circuit board with a capacitive touch sensor trace provided on an upper surface and where at least one portion of the upper surface is curved with the same curvature as the one portion of the touch panel. When the printed circuit board is mounted to the touch panel such that the capacitive touch sensor trace is aligned with the touch area the second curved surface nests within the first curved surface.

### BRIEF DESCRIPTION OF THE DRAWINGS

In the drawings:

FIG. 1 is a schematic, cross-sectional view of a dishwasher according to a first embodiment of the invention.

FIG. 2 is a schematic view of a controller of the dishwasher of FIG. 1.

FIG. 3 is an exploded view of an exemplary controller and user interface, which may be used in the dishwasher of FIG. 1.

FIG. 4 is a cross-sectional view of the controller and user interface of FIG. 3.

FIG. 5 is a rear perspective view of the controller and user interface illustrated in FIG. 3.

FIG. 6 is a front view of the exemplary user interface of FIG. 3 installed in the dishwasher of FIG. 1.

### DESCRIPTION OF EMBODIMENTS OF THE INVENTION

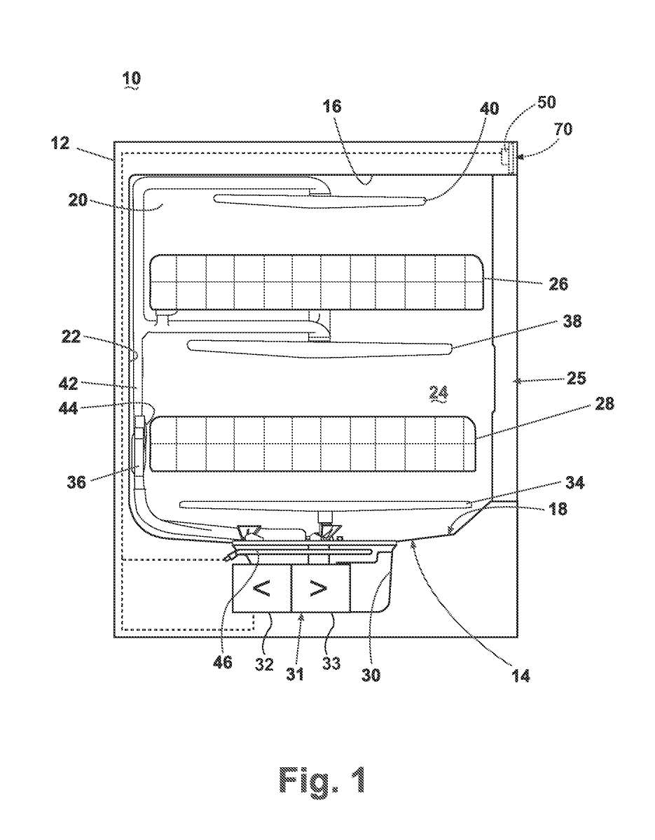

In FIG. 1, a first embodiment of the invention is illustrated in the environment of an automated dishwasher 10 having a chassis 12. The chassis 12 defines an interior and may be a frame with or without panels mounted to the frame. The dishwasher 10 shares many features of a conventional automated dishwasher, which will not be described in detail herein except as necessary for a complete understanding of the invention. The chassis 12 houses an open-faced wash tub 14 having spaced top and bottom walls 16 and 18, spaced sidewalls 20, and a rear wall 22. The walls 16, 18, 20, and 22 collectively define a treating chamber 24, having an open face, for washing utensils. A door assembly 25 may be movably mounted to the dishwasher 10 for movement between opened and closed positions to selectively open and close the open face of the wash tub 14. Thus, the door assembly provides accessibility to the treating chamber 24 for the loading and unloading of dishes or other washable items.

It should be appreciated that the door assembly 25 may be secured to the lower front edge of the chassis 12 or to the lower front edge of the wash tub 14 via a hinge assembly (not shown) configured to pivot the door assembly 25. When the door assembly 25 is closed, user access to the treating chamber 24 may be prevented, whereas user access to the treating chamber 24 may be permitted when the door assembly 25 is open.

Utensil holders, illustrated in the form of upper and lower utensil racks 26, 28, are located within the treating chamber 24 and receive dishes for washing. The upper and lower racks 26, 28 are typically mounted for slidable movement in and out of the treating chamber 24 for ease of loading and unloading. Other utensil holders may be provided, such as a silverware basket. As used in this description, the term “utensil(s)” is intended to be generic to any item, single or plural, that may be treated in the dishwasher 10, including, without limitation; dishes, plates, pots, bowls, pans, glassware, and silverware.

While the present invention is described in terms of a conventional dishwashing unit as illustrated in FIG. 1, it could also be implemented in other types of dishwashing units such as in-sink dishwashers or drawer dishwashers including drawer dishwashers having multiple compartments. For drawer-type dishwashers, the surrounding cabinet in combination with the sliding drawer takes the place of the door assembly 25.

A spray system is provided for spraying liquid in the treating chamber 24 and is provided in the form of a first lower spray assembly 34, a second lower spray assembly 36, a rotating mid-level spray arm assembly 38, and/or an upper spray arm assembly 40. Upper sprayer 40, mid-level rotatable sprayer 38 and lower rotatable sprayer 34 are located, respectively, above the upper rack 26, beneath upper rack 26, and beneath the lower rack 28 and are illustrated as rotating spray arms. The second lower spray assembly 36 is illustrated as including a vertically oriented distribution header or spray manifold 44 and being located adjacent the lower utensil rack 28 toward the rear of the treating chamber 24. Such a spray manifold is set forth in detail in U.S. Pat. No. 7,594,513, issued Sep. 29, 2009, and titled “Multiple Wash Zone Dishwasher,” which is incorporated herein by reference in its entirety.

A recirculation system is provided for recirculating liquid from the treating chamber 24 to the spray system. The recirculation system may include a sump 30 and a pump assembly 31. The sump 30 collects the liquid sprayed in the treating chamber 24 and may be formed by a sloped or recess portion of a bottom wall 18 of the tub 14. The pump assembly 31 may include both a drain pump 32 and a recirculation pump 33. The drain pump 32 may draw liquid from the sump 30 and pump the liquid out of the dishwasher 10 to a household drain line (not shown). The recirculation pump 33 may draw liquid from the sump 30 and the liquid may be simultaneously or selectively pumped through a supply tube 42 to each of the assemblies 34, 36, 38, 40 for selective spraying. While not shown, a liquid supply system may include a water supply conduit coupled with a household water supply for supplying water to the treating chamber 24.

A heating system including a heater 46 may be located within the sump 30 for heating the liquid contained in the sump 30.

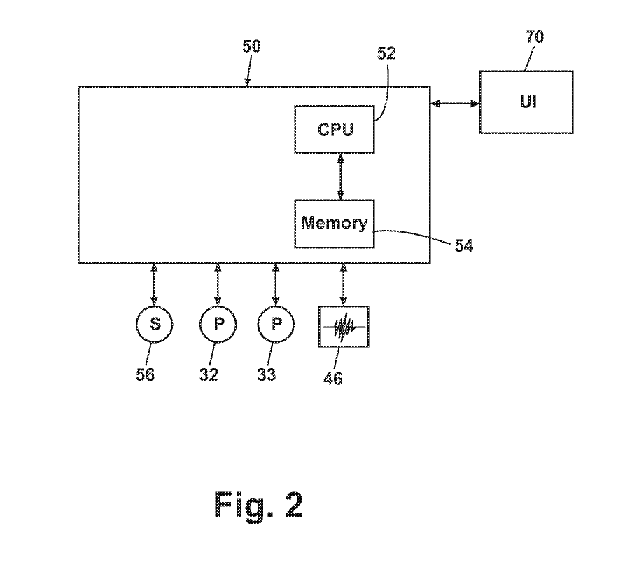

A controller 50 may also be included in the dishwasher 10, which may be operably coupled to various components of the dishwasher 10 to implement a cycle of operation. The controller 50 may be located somewhere with the chassis 12 as illustrated, or it may alternatively be located within the door assembly 25. As illustrated schematically in FIG. 2, the controller 50 may be coupled with heater 46 for heating the wash liquid during a cycle of operation, the drain pump 32 for draining liquid from the treating chamber 24, the recirculation pump 33 for recirculating the wash liquid during the cycle of operation. The controller 50 may be provided with a central processing unit (CPU) 52 and memory 54. The memory 54 may be used for storing control software that may be executed by the CPU 52 in completing a cycle of operation using the dishwasher 10 and any additional software. For example, the memory 54 may store one or more pre-programmed cycles of operation that may be selected by a user and completed by the dishwasher 10.

The controller 50 may also receive input from one or more sensors 56. Non-limiting examples of sensors that may be communicably coupled with the controller 50 include a temperature sensor, turbidity sensor to determine the soil load associated with a selected grouping of utensils, such as the utensils associated with a particular area of the treating chamber and a sensor for determining a load value at selected locations within the dishwasher 10. The load value may be reflective of either or both a utensil load, i.e. the number and/or size of the utensils in the dishwasher, and/or a soil load, i.e. the quantity of soil on the utensils.

The controller 50 may also be operably coupled with a user interface 70 for receiving user-selected inputs and communicating information to the user. The user interface 70 may be used to select a cycle of operation or to set one or more operating parameters to modify one of the pre-programmed cycles of operation according to the user's preferences. The operating parameters may correspond, for example, to a type of utensil, a soil level, or an amount of utensils in the load. To facilitate such selections, the user interface 70 may include capacitive touch sensing technology or capacitive touch sensors for receiving input from a user.

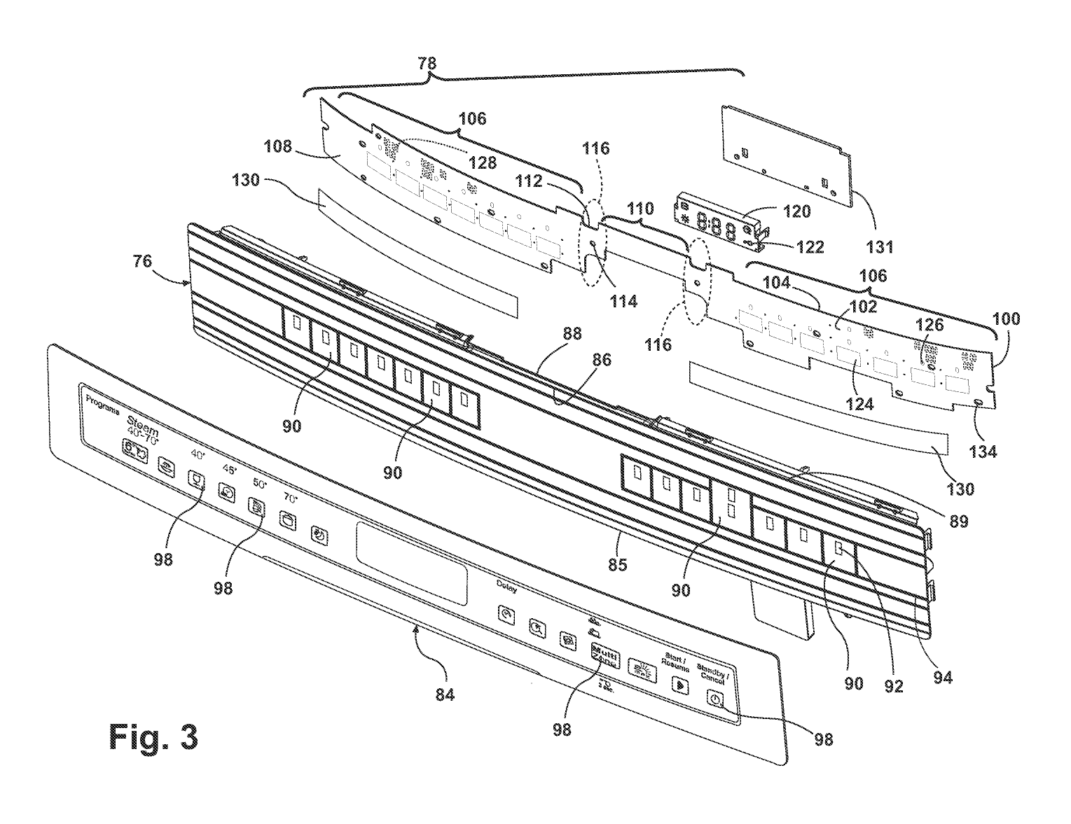

FIG. 3 illustrates an exploded view of exemplary components, which may make up the controller 50 and the user interface 70. The components collectively include a touch panel 76, a printed circuit board (PCB) 78, and a label 84.

The touch panel 76 has been illustrated as including a body 85 having a front surface 86, a rear surface 88, and a plurality of touch areas 90 defined on the front surface 86. A portion of the touch area 90 has been illustrated as having a textured surface 92. Channels 94 may also be provided in the front surface 86 of the touch panel 76. At least one portion of the rear surface 88 may be curved to define a first curved surface 96. In the illustrative embodiment, both the entirety of the front surface 86 and the entirety of the rear surface 88 are curved although this need not be the case.

The label 84 includes one or more graphics 98 that indicate or define where the touch areas 90 are located. The label 84 may include a substantially clear polymeric plastic, or similar material, film with one or more graphics 98 printed on the film. The graphic may be any type of indicia such as alphanumeric symbols, shapes, patterns or symbols, which may be selected to allow a user to select various cycles of operation and parameters. It has been contemplated that one or more graphic layers may be provided. For example, the graphic layers may include a layer of black paint with graphics in white provided thereon which may correspond to the touch area 90 locations. The label 84 may be adhered or otherwise affixed to the front surface 86 of the touch panel 76 during assembly. Alternatively, the graphics may be applied directly to the body 85 such as by printing or painting.

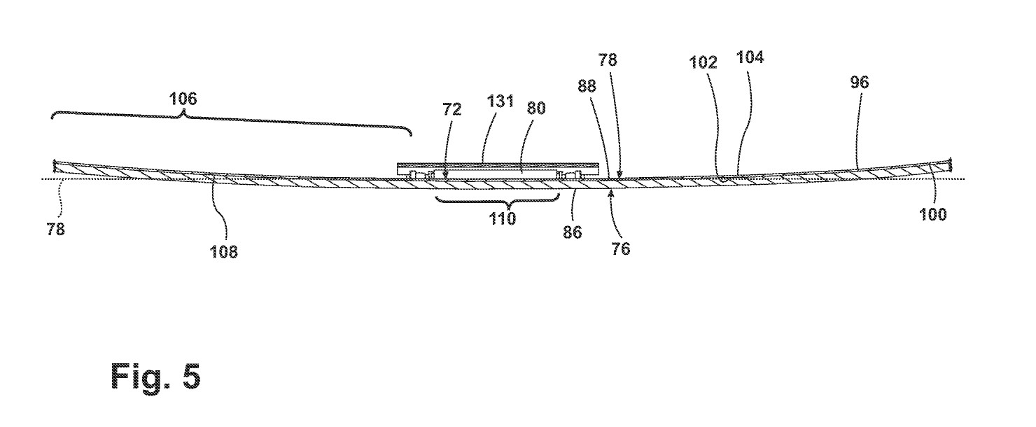

The PCB 78 has a planar body 100 that defines an upper or front surface 102 and a lower or back surface 104 of the PCB 78. The planar body 100 may be formed from FR4, or a similar material, which allows the planar body 100 to be flexible such that the planar body 100 may be flexible between a planar orientation (illustrated by the dashed line in FIG. 5) and a curved orientation (illustrated in FIGS. 3 and 5).

It is contemplated that in the curved orientation, the planar body 100 may include one or more first portions 106, which may be curved with a second amount of curvature that is commensurate with the first curved surface 96 of the touch panel 76. In this manner the first portion 106 may define a second curved surface 108 along the front surface 102 and a similar curved surface along the back surface 104. Further, in the curved orientation the planar body 100 may include a second portion 110 having an amount of curvature less than the second curved surface 108. As the second portion 110 has an amount of curvature less than the second curved surface 108 it has been contemplated that the second portion 110 may have no amount of curvature such that it is flat. As illustrated, the planar body 100 has two first portions 106 defining two second curved surfaces 108 that each has an amount of curvature that is the same as the first curved surface 96. The two first portions 106 are illustrated as being separated by the second portion 110 such that the PCB 78 has two separate second curved surfaces 108.

Two spaced cutouts 112 and two spaced holes 114 are included in the planar body 100. The cutouts 112 and holes 114, alone or in combination, form two bending weakened areas 116 that have reduced bending resistance such that flexing of the planar body 100 creates a greater bending at the bending weakened areas 116. The second portion 110 has been illustrated as being located between the bending weakened areas 116. The location of the two bending weakened areas 116 provides that when the PCB 78 is flexed, the first portions 106 will bend a greater amount than the second portion 110. That is, the bending of each of the first portions 106 happens generally between one of the bending weakened areas 116 and the opposite end of the first portion 106, with little to no bending on the second portion 110. In this way, the bending weakened areas 116 provide for the second portion 110 to form a generally flat portion while the first portions are curved. Additional bending weakened areas may be included in the planar body 100. By way of non-limiting example one of the first portions 106 of the planar body 100 may include additional bending weakened areas to allow for a greater bending of the first portion 106 at the bending weakened areas.

The PCB 78 may also include various electrical components including a microprocessor 120, a display 122, a capacitive touch sensor trace 124, LED's 126, and other various electronic components 128 necessary for form the corresponding circuitry. The microprocessor 120 has been illustrated separately from the PCB 78 for illustrative purposes only and it is contemplated that the microprocessor 120 may be affixed to the back surface 104 of the PCB 78 at the second portion 110. Mounting the microprocessor 120 to the flatter second portion 110 avoids cracking of the soldered joints during assembly. The PCB 78 may also include a display 122, which may be viewed through a portion of the touch panel 76. The capacitive touch sensor traces 124 (shown schematically) may be provided on the front surface 102 of the planar body 100 and may act as a conductor of a capacitive sensor. The touch sensor traces 124 may be copper, carbon, silver, or similar conductive materials, which are laid out on the planar body 100 of the PCB 78. As illustrated the capacitive touch sensor traces 124 may be located on the first portion 106 and each touch sensor trace 124 may be associated with a corresponding touch area 90 on the touch panel 76. The PCB 78 may also include at least one light source mounted to the planar body 100. As illustrated, the PCB 78 includes a plurality of LEDs 126, which may be positioned on the back surface 102 of the PCB 78 and may emit light through corresponding openings in the planar body 100. Various electronic components 128 (shown in phantom), such as resistors and capacitors, may also be mounted to the planar body 100 and have been illustrated as being located on the first portion 106 on the back surface 104. Thin traces (not shown) may be used to connect the microprocessor 120, touch sensor traces 124, LEDs 126, and electronic components 128. A capacitive sensor may be formed by an electric circuit on the planar body 100, which may include a capacitive touch sensor trace 124, at least one electronic component 128, and the microprocessor 120. The controller 50 may be formed from portions of the PCB 78 including the microprocessor 120 and the other electrical components.

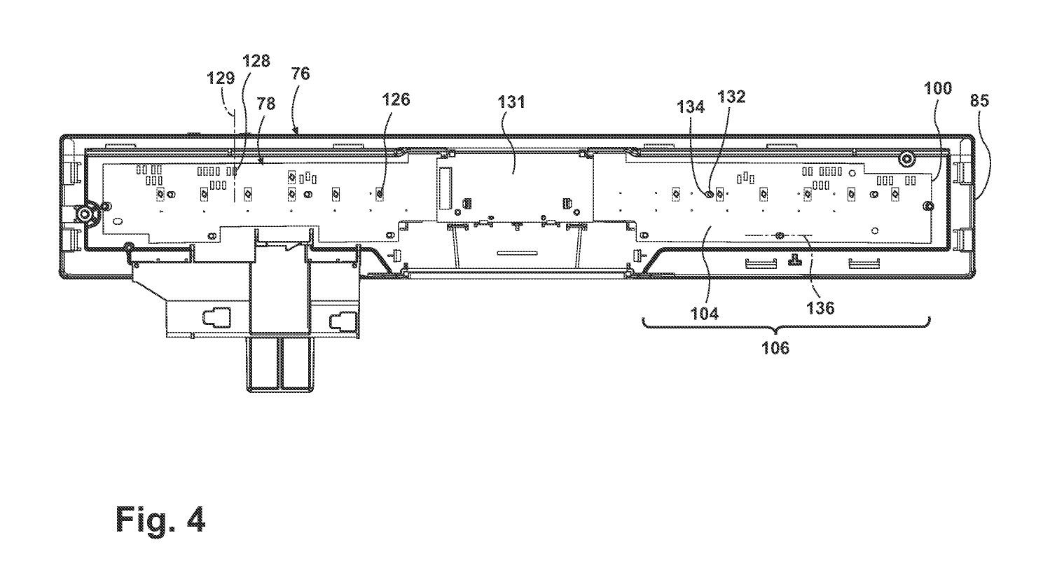

As better seen in FIG. 4 the electronic components 128 may be elongated and each may define a longitudinal axis 129, which may be oriented substantially perpendicular to the curvature across the first portion 106 such that the longitudinal axis 129 is not oriented along the curvature of the first portion 106. Solder joints (not shown) may be used to mount each longitudinal end of the electronic components 128 to the PCB 78. With the electronic components 128 vertically oriented there may be very little curvature of the PCB 78 across the electronic components 128 resulting in the solder joints being less prone to breakage when the PCB 78 is flexed and mounted to the touch panel 76.

Referring again to FIG. 3, a layer of pressure sensitive adhesive 130 may be applied on the touch sensor traces 124 to aid in mounting the PCB 78 to the touch panel 76. The adhesive 130 may be a double side adhesive, which may be applied first to the PCB 78. The touch panel 76 may also include multiple mounting pins 132 projecting from the first curved surface 96 and the PCB 78 may include multiple corresponding elongated openings 134. Each of the elongated openings 134 may be thought of as defining a longitudinal axis 136 along its length. Each elongated opening 134 may receive one of the mounting pins 132 to aid in coupling the PCB 78 to the touch panel 76. During operation, the elongated openings 134 permit the thermal expansion/contraction of the PCB 78 and related horizontal movement of the PCB 78 along the longitudinal axis. The pins 132 may be hot melt pins that allow for fixation of the PCB 78 to the curved touch panel 76 and ensure good compression of the adhesive layer 130 and protect against separation of the PCB 78 from the curved touch panel 76.

During assembly, the label 84 may be adhered to the front surface 86 of the touch panel 76 and the channels 94 in the front surface 86 of the touch panel 76 enable proper adhesion of the label 84 to the touch panel 76 and aid in the removal of any air bubbles between the label 84 and the front surface 86 during the adhesion process. The channels 94 allow any entrapped air to be vented to the exterior of the touch panel 76 so that no air bubbles will be entrapped therein. Entrapped air bubbles may be cosmetically objectionable and degrade performance of a capacitive touch sensor.

During assembly, the PCB 78 may be attached to the touch panel 76 using the adhesive 130. When the PCB 78 is mounted to the touch panel 76 the capacitive touch sensor traces 124 are aligned with the touch areas 90 and the second curved surfaces 108 of the PCB 78 nest within the first curved surface 96 of the rear surface 88 of the touch panel 76. The adhesive force may be applied from the center to the sides to aid in the removal of air bubbles and ensure uniform lamination. The adhesive 130 ensures no air gaps between the PCB 78 and the first curved surface 96, which results in better performance as even small air bubbles may results in sensor performance degradation.

As illustrated in FIG. 5, the PCB 78 may be mounted to the rear surface 88 of the touch panel 76 such that the second curved surfaces 108 abut the first curved surface 96 and a portion of the second curved surface 108 may be bonded to at least a portion of the first curved surface 96 through the adhesive 130. A support plate 131 may be mounted over the microprocessor 120 and may be affixed to the touch panel 76 to aid in the mounting of the PCB 78 to the touch panel 76.

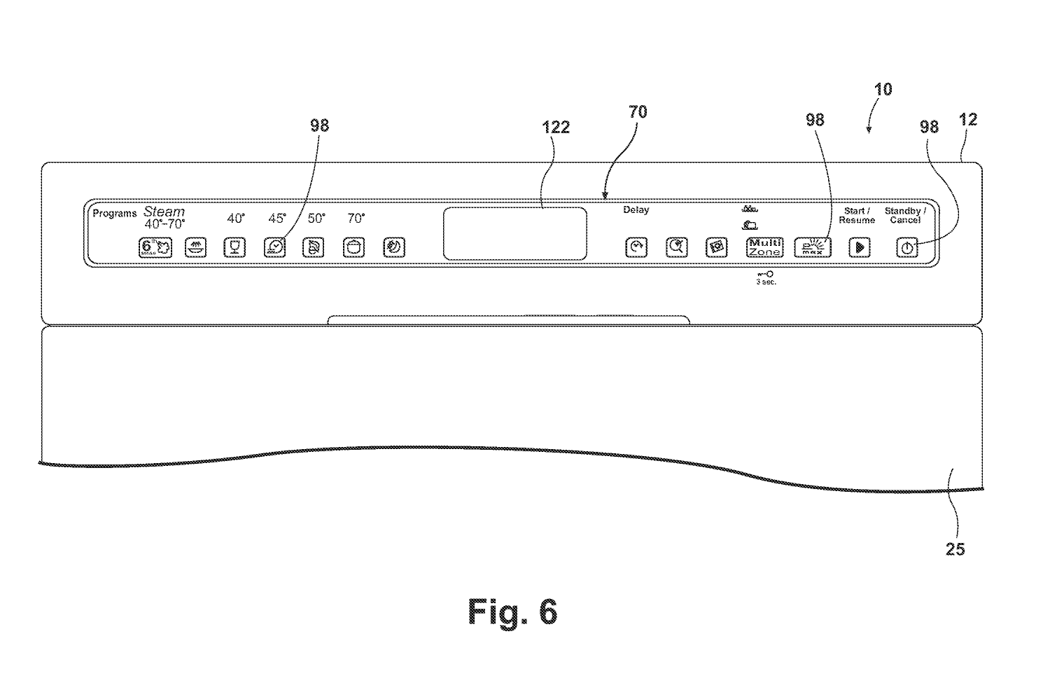

FIG. 6 illustrates the assembled user interface 70 mounted in the chassis 12. The user interface 70 may comprise the touch panel 76, the label 84, the display 122, and portions of PCB 78 including the LEDs 126 to communicate information to the user and operational controls to receive information about the selected cleaning cycle and operating parameters. The operational controls are illustrated as capacitive touch sensors formed by the touch areas 90 overlying the touch sensor traces 124 and are denoted to a user by the graphics 98. The touch sensor may be sensitive to the position of one or more input objects, such as a user's finger, within or near the touch areas 90 such that the capacitive touch sensors are able to detect a position or motion of the object. More specifically, the electric circuit has an electrical current running through it and voltage is applied to create an electric field across the touch areas 90. The field may extend from the touch area 90 for a distance into space until signal-to-noise ratios prevent object detection. This distance the field may extend may be on the order of less than a millimeter, millimeters, centimeters, or more, and may vary significantly with the type of position sensing technology used and the accuracy desired.

An object, such as a user's finger, moving into the field near the touch areas 90 causes a voltage or signal change. The capacitive touch sensor detects the position of the object by detecting capacitance (e.g., changes in capacitance or absolute capacitance) that result from the location of the object and provides electrical or electronic information of the position of the object to the microprocessor 120. In general, the microprocessor 120 receives electrical signals from the touch sensor and appropriately processes the information to accept inputs from the user to control the user interface 70. This information may be relayed from the user interface 70 to the controller 50 to control the operation of the dishwasher 10.

When the user selects one of the cycles or options on the user interface 70, the corresponding LED 126 may light up. Because the touch panel 76 may be formed from transparent material, it may transfer light from the LED 126 to the front surface 86. The textured surface 92 may act to disperse the light emitted from the LED 126 to the touch area 90, thereby, illuminating the touch area 90.

The apparatus described above allows the user interface to have a curved touch panel, which may be directly attached to a PCB without the need for capacitance carrying extensors such as rubbers, springs, or films which are needed when curved touch panels are used with planar PCB configurations. The ability of the PCB to flex allows the traces to be provided on the curved portions of the PCB along the curve surface of the touch panel. The ability of the PCB to have a flat portion while the remainder of the body is flexed provides a place for mounting the processor where solder joints used for mounting will not crack. The ability to place the microprocessor on the flat center area also enables a symmetrical lay-out of the traces which enables better sensitivity of the sensors and easier calibration. The flexibility of the PCB along with the pressure sensitive adhesive allows the traces to be bonded to the touch areas such that they may be directly attached without the need for capacitance carrying extensors which would otherwise be needed. Further, as the traces are adhered directly to the touch panel, no air gaps are located between them allowing for less disruption in the capacitance field. Thus, the described apparatus results in a cost reduction as fewer parts are needed. The above described apparatus also allows the PCB the ability to move relative to the touch panel during thermal expansion/contraction, which, along with the adhesive, keeps the capacitive traces aligned with the touch areas and adhered thereto such that the field strength of the sensor will not be lost. Further, the PCB is less likely to buckle during use because the PCB has the ability to move relative to the touch panel during thermal expansion/contraction.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A user interface comprising:
a touch panel having opposed front and rear surfaces, with a touch area defined on the front surface, and where at least one portion of the rear surface is curved to define a first curved surface; and
a printed circuit board having upper and lower surfaces, with a capacitive touch sensor trace provided on the upper surface, and where at least one portion of the upper surface is curved with the same curvature as the one portion of the touch panel to define a second curved surface;
wherein the printed circuit board is mounted to the touch panel such that the capacitive touch sensor trace is aligned with the touch area and the second curved surface nests within the first curved surface.

2. The user interface of claim 1 wherein the printed circuit board comprises a planar body defining the upper and lower surfaces of the printed circuit board, with the planar body being flexible between a planar orientation and a curved orientation, where the upper surface comprises a first and a second portion, with the first portion defining the second curved surface, and the second portion having an amount of curvature less than the second curved surface.

3. The user interface of claim 2 wherein the second portion has no amount of curvature.

4. The user interface of claim 2 wherein the planar body further comprises at least two spaced bending weakened areas having a reduced bending resistance such that flexing of the planar body creates a greater bending at the bending weakened areas, and the second portion is located between the bending weakened areas.

5. The user interface of claim 4 wherein the first portion of the planar body comprises additional bending weakened areas having a reduced bending resistance such that flexing of the planar body creates a greater bending of the first portion at the bending weakened areas.

6. The user interface of claim 4 wherein the bending weakened areas are formed by at least one of cutouts and holes in the planar body.

7. The user interface of claim 2 wherein the capacitive touch sensor trace is located on the first portion.

8. The user interface of claim 7 wherein the printed circuit board further comprises a microprocessor mounted on the second portion.

9. The user interface of claim 8 wherein the printed circuit board further comprises at least one elongated electronic component having a longitudinal axis, which is oriented substantially perpendicular to the curvature of the second curved surface.

10. The user interface of the claim 2 wherein the first portion comprises two first portions separated by the second portion such that the printed circuit board has two separate second curved surfaces.

11. The user interface of claim 1 wherein the second curved surface abuts the first curved surface.

12. The user interface of claim 11 wherein at least a portion of the second curved surface is bonded to at least a portion of the first curved surface.

13. The user interface of claim 11 wherein the touch panel comprises multiple mounting pins projecting from the first curved surface and the printed circuit board comprises corresponding multiple elongated openings, each defining a longitudinal axis, with each of the multiple openings receiving one of the mounting pins to couple the printed circuit board to the touch panel while permitting expansion and contraction of the printed circuit board along the longitudinal axis.

14. The user interface of claim 1, further comprising indicia on the touch panel to define the touch area.

15. The user interface of claim 14, further comprising a label affixed to the front surface of the touch panel, with the label bearing the indicia.

16. The user interface of claim 15 wherein the touch panel further comprises channels provided in the front surface for removal of air bubbles between the label and the front surface.

17. A user interface comprising:
a touch panel having opposed front and rear surfaces, with a touch area defined on the front surface, and where at least one portion of the rear surface is curved to define a first amount of curvature; and
a printed circuit board comprising:
a planar body with front and rear surfaces and flexible between a planar orientation and a curved orientation, where the planar body comprises first and second portions, with the first portion having a second amount of curvature commensurate with the first amount of curvature, and the second portion having an amount of curvature less than the second amount of curvature; and
at least one electric circuit on the planar body comprising at least one electronic component, a microprocessor, and a capacitive touch sensor trace, with the capacitive touch sensor trace located on the front surface of the first portion, the at least one electronic component located on the rear surface of the first portion, and the microprocessor located on the rear surface of the second portion;
wherein the printed circuit board is mounted to the touch panel such that the capacitive touch sensor trace is aligned with the touch area and the first portion nests with the rear surface of the touch panel.

18. The user interface of claim 17 wherein the second portion has no amount of curvature.

19. The user interface of claim 17 wherein the planar body further comprises at least two spaced bending weakened areas having a reduced bending resistance such that flexing of the planar body creates a greater bending at the bending weakened areas, and the second portion is located between the bending weakened areas.

20. The user interface of claim 19 wherein the bending weakened areas are formed by at least one of cutouts and holes in the planar body.

21. The user interface of claim 19 wherein the first portion of the planar body comprises additional bending weakened areas having a reduced bending resistance such that flexing of the planar body creates a greater bending of the first portion at the bending weakened areas.

22. The user interface of claim 17 wherein the at least one electronic component is elongated and defines a longitudinal axis, which is oriented substantially perpendicular to the curvature of the first portion.

23. The user interface of claim 17 wherein the first portion abuts the rear surface at least at the capacitive touch sensor trace.

24. The user interface of claim 23 wherein the first portion is bonded to the rear surface at least at the capacitive touch sensor trace.

25. The user interface of claim 17 wherein the touch panel further comprises multiple mounting pins projecting from the rear surface and the planar body further comprises corresponding multiple elongated openings, each defining a longitudinal axis, with each of the multiple openings receiving one of the mounting pins to couple the planar body to the touch panel while permitting expansion and contraction of the planar body along the longitudinal axis.

26. The user interface of claim 17, further comprising indicia provided on the touch panel to define the touch area.

27. The user interface of claim 26, further comprising a label affixed to the front surface of the touch panel, with the label bearing the indicia.

28. The user interface of claim 27 wherein the touch panel further comprises channels provided in the front surface for removal of air bubbles between the label and the front surface.

29. The user interface of the claim 17 wherein the first portion comprises two first portions separated by the second portion such that the printed circuit board has two separate second curved surfaces.

30. The user interface of claim 29 wherein the touch panel has a rear surface that includes two curved surfaces and each of the two first portions abut a rear curved surface of the touch panel.
